(19) United States
(12) Patent Application Publication
(10) Pub. No.: US 2023/0322022 A1
(43) Pub. Date: Oct. 12, 2023

(54) DEVICE AND METHOD FOR ASSISTING WHEEL ASSEMBLIES

(71) Applicant: Jerry White, Jr., Juneau, AK (US)

(72) Inventor: Jerry White, Jr., Juneau, AK (US)

(21) Appl. No.: 17/717,424

(22) Filed: Apr. 11, 2022

(51) Int. Cl. B60B 31/04; B60B 25/00

(52) U.S. Cl. CPC B60B 31/04; B60B 25/002; B60B 2320/14; B60B 2310/305; B60B 2900/3314; B60Y 2200/50; B60B 2900/212

(57) ABSTRACT

A device and method for assisting a user in aircraft wheel assemblies is disclosed herein. The device enables a single user to readily connect two wheel sections in a split wheel assembly. The device is lightweight and reusable and preferably includes two bushings, two washers, a bolt, and a nut. After inserting the bolt through the wheel sections, a nut can be tightened, thereby creating a compressive force that compresses the bushings and the wheel sections together. While the wheel sections are compressed together, a plurality of tie bolts and tie nuts can be installed on the wheel sections to complete the wheel assembly.

### CROSS-REFERENCE TO RELATED APPLICATIONS

This is a Nonprovisional Utility U.S. Patent Application filed under 37 CFR 1.53(b).

### BACKGROUND OF THE INVENTION

### 1. Field of the Invention

The present disclosure relates generally to aircraft wheel assemblies. More specifically, the disclosure relates to devices and methods to assist in aircraft wheel assemblies with tie bolt retention systems.

### 2. Description of Related Art

An aircraft wheel is comprised of at least two parts assembled together. Each part is commonly referred to as a wheel half, or outboard and inboard wheel sections. Each wheel half has a wheel bearing located in the center of the assembly, concentric holes for tie bolts, outer edge that contacts tires and an inner mating surface. The outer edge is often referred to as the bead area. There are two different methods for retaining air within the wheel/tire assembly. They are commonly referred to as a tube type or non-tube type design. Tube type designs use an inner tube to container the air within the wheel/tire assembly. Non-tube types use an O-ring at the inner mating surface and the bead contact area to create the seal. The wheel halves are retained together by the use of tie bolts and nuts. Regardless of the type, with both the wheels exert a compressive force on the tire at the bead area. Some tires have very stiff sidewall properties. The compressive force needed to bring the two wheel halves together for tie bolt installation exceeds one person's ability. The use of multiple people or improvised methods for assembling such wheels increases the likelihood of damaged wheels and injury to persons. Thus, there is a need in the field for a device for assisting in a wheel assembly.

### SUMMARY OF THE INVENTION

It is an object of the invention to provide a device for assisting a user in aircraft wheel assemblies. Another object of the invention is to provide a device enabling a single user to readily connect two wheel sections in a split wheel assembly. It is another object of the invention to provide a device that is lightweight and reusable. The device preferably includes two bushings, two washers, a bolt, and a nut. After inserting the bolt through the wheel sections, a nut can be tightened, thereby creating a compressive force that compresses the bushings and the wheel sections together. While the wheel sections are compressed together, a plurality of tie bolts and tie nuts can be installed on the wheel sections to complete the wheel assembly.

These and other features and advantages will be apparent from reading of the following detailed description and review of the associated drawings. It is to be understood that both the forgoing general description and the following detailed description are explanatory and do not restrict aspects as claimed.

### BRIEF DESCRIPTION OF THE DRAWINGS

FIG. 1 illustrates a side view of a device for assisting in a wheel assembly.

FIG. 2 illustrates an exploded view of the wheel assembly device.

FIG. 3 illustrates a side view of the device assembled and partially tightened.

FIG. 4A illustrates a front view of the device and FIG. 4B illustrates a rear view of the device.

FIG. 5 illustrates a cross-sectional view of the device.

FIG. 6 illustrates a cross-sectional view of the device operatively connected to a bearing of a wheel assembly.

FIG. 7 illustrates the device operatively connected to a first wheel section of a split wheel assembly.

FIG. 8 illustrates a front perspective view of a split wheel assembly showing the bolt head end at the first wheel section.

FIG. 9 illustrates a rear perspective view of a split wheel assembly showing the bolt head end at the second wheel section.

FIG. 10 illustrates a perspective view of a split wheel assembly with the first wheel section and the second wheel section fully compressed together.

### DETAILED DESCRIPTION OF EMBODIMENTS

The following descriptions relate principally to preferred embodiments while a few alternative embodiments may also be referenced on occasion, although it should be understood that many other alternative embodiments would also fall within the scope of the invention. The embodiments disclosed are not to be construed as describing limits to the invention, whereas the broader scope of the invention should instead be considered with reference to the claims, which may be now appended or may later be added or amended in this or related applications. Unless indicated otherwise, it is to be understood that terms used in these descriptions generally have the same meanings as those that would be understood by persons of ordinary skill in the art. It should also be understood that terms used are generally intended to have the ordinary meanings that would be understood within the context of the related art, and they generally should not be restricted to formal or ideal definitions, conceptually encompassing equivalents, unless and only to the extent that a particular context clearly requires otherwise.

For purposes of these descriptions, a few wording simplifications should also be understood as universal, except to the extent otherwise clarified in a particular context either in the specification or in particular claims. The use of the term “or” should be understood as referring to alternatives, although it is generally used to mean “and/or” unless explicitly indicated to refer to alternatives only, or unless the alternatives are inherently mutually exclusive. Furthermore, unless explicitly dictated by the language, the term “and” may be interpreted as “or” in some instances. When referencing values, the term “about” may be used to indicate an approximate value, generally one that could be read as being that value plus or minus half of the value. “A” or “an” and the like may mean one or more, unless clearly indicated otherwise. Such “one or more” meanings are most especially intended when references are made in conjunction with open-ended words such as “having,” “comprising” or “including.” Likewise, “another” object may mean at least a second object or more. Thus, in the context of this specification, the term “comprising” is used in an inclusive sense and thus should be understood as meaning “including, but not limited to.” As used herein, the use of “may” or “may be” indicates that a modified term is appropriate, capable, or suitable for an indicated capacity, function, or usage, while considering that in some circumstances the modified term may sometimes not be appropriate, capable, or suitable. “Plurality” is defined as more than one when used to describe a quantity in the specification and claims. Any “examples” of embodiments and components (e.g. dimensions) described herein are considered non-limiting examples.

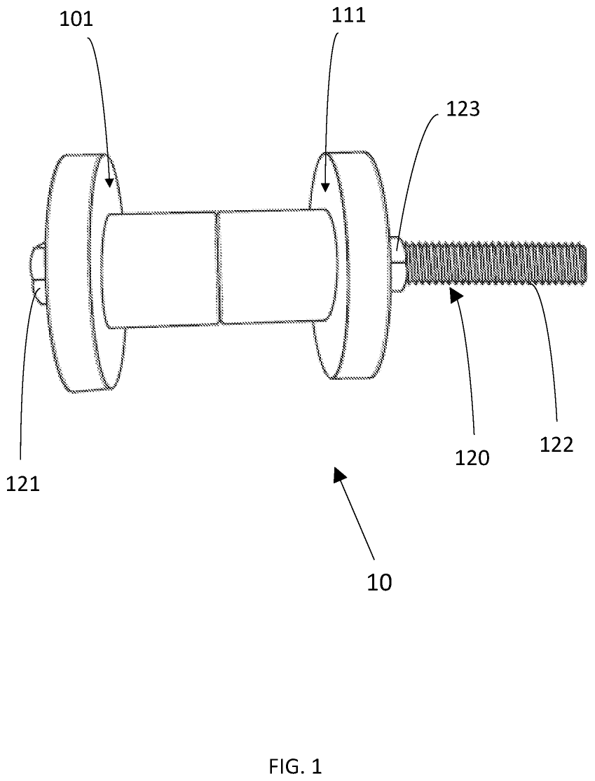

FIG. 1 illustrates a side view of a device 10 for assisting in a wheel assembly. The device 10 is shown with a nut 123 fully tightened on a bolt 120, thereby compressing a first bushing 101 and a second bushing 111 together.

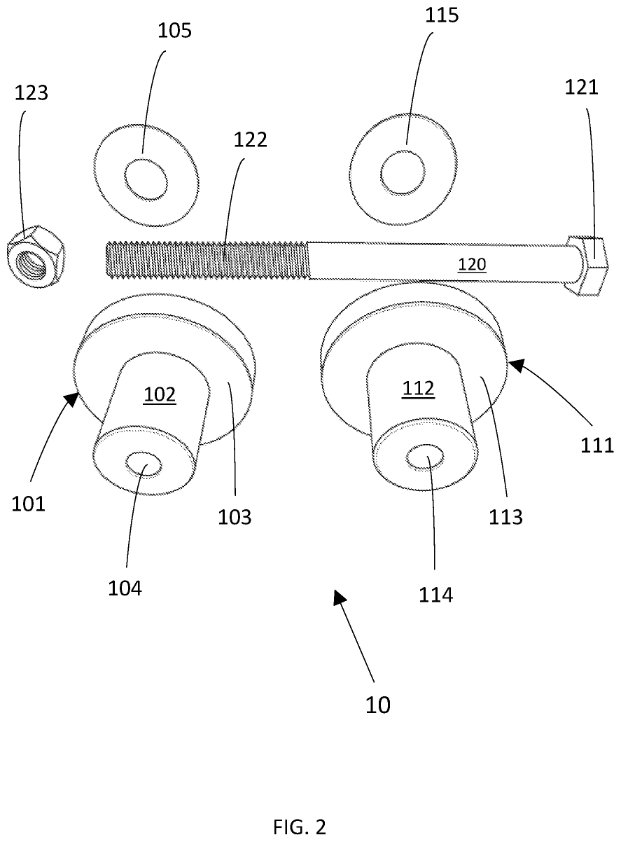

FIG. 2 illustrates an exploded view of the wheel assembly device 10. The device includes a first bushing 101 and a second bushing 111. The bushings are preferably identical in size, both being cylindrical and T-shaped. For example, the first bushing 101 includes a longer and narrower cylinder 102 connected to a shorter and wider cylinder 103. The first bushing 101 also includes a cylindrical hole 104 passing completing through the center of the bushing 101 lengthwise. The second bushing 111 is identical in size and shape, including the same components as the first bushing 101 and a cylindrical hole 114. The bushings can have various dimensions in accordance with the invention. For example, the outward flange (shorter/wider cylinder) 103, 113 can have a three inch diameter and ½ (one-half) inch length, while the inner body (longer/narrower cylinder) 102, 112 can have a 1.5 inch diameter and a 1.5 inch length. The cylindrical holes in the bushings 104, 114 can be ½ (one-half) inch in diameter, for example.

A T-shaped design of the bushings 101, 111 ensures the wheel halves (sections) can be drawn together with the inner mating surfaces parallel to each other. The bushings can be comprised of various materials including aluminum. Bushings comprised of aluminum have useful properties such as rigidity, durability, and thermal expansion properties similar to wheel assemblies. The edges of the bushings can be filleted to prevent injury to users and prevent damage to wheel assemblies. Filleted edges of bushings can also reduce stress concentration loads at the transition from the flange 103 to the body 102 of the bushing 101.

Further, the device 10 includes a first washer 105 and a second washer 115. The washers 105, 115 are preferably circular shaped and comprised of a low carbon steel. The washers can be zinc-coated to provide corrosion resistance. Washers are implemented in the device 10 to prevent the bushings 101, 111 from spinning when installed in a wheel assembly. Further, the washers 105, 115 can prevent galling of the surfaces of the bushings.

Additionally, the device 10 includes a bolt 120 with a head end 121 and a threaded end 122. The bolt 120 can be comprised of various materials including steel. For example, the bolt 120 can be an ASTM A307 Grade A steel bolt. Bolts with various dimensions can be implemented. For example, the bolt 120 can have a ½ (one-half) inch diameter and a length of seven inches measured from under the bolt head 121 to the end of the threaded end 122. For a bolt length of seven inches, the bolt grip length can be 3.875 inches with a threaded portion length of 3.125 inches. It is desirable to have a threaded portion of sufficient length for proper compression of the wheel assembly. If the threaded portion is too long, over compression of the wheel assembly can occur when tightened. The threaded end 122 of the bolt 120 can include a coarse thread pitch, enabling quick installation and removal of the device 10 in wheel assemblies. The thread pitch can vary and in one example the thread pitch can be thirteen threads per inch (13 TPI). Further, the device 10 includes a nut 123 with threads configured to engage with the threaded end 122 of the bolt. The nut 123 can be comprised of various materials. In this example, the nut 123 is a standard ½ (one-half) inch-13 grade 5 medium carbon nut with a zinc yellow-chromate plated finish.

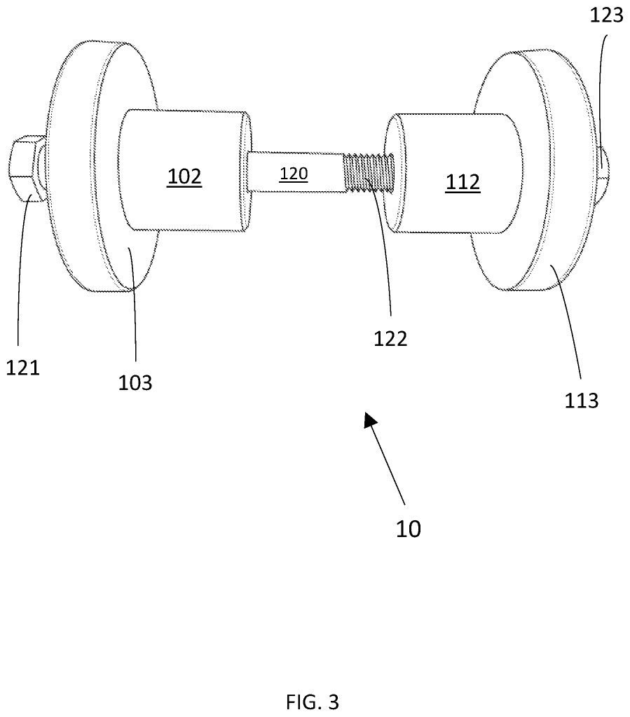

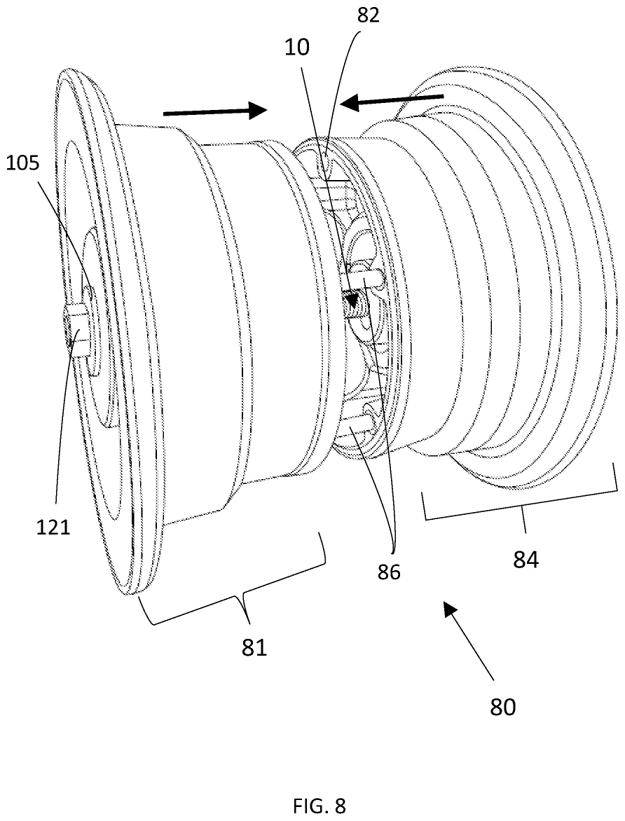

FIG. 3 illustrates a side view of the device 10 assembled and partially tightened. The device 10 can be implemented in various methods of assembling a wheel assembly. As aforementioned, an aircraft wheel includes two wheel halves (sections). With reference to FIG. 8, these wheel halves are often referred to as an inboard wheel section 81 and an outboard wheel section 84.

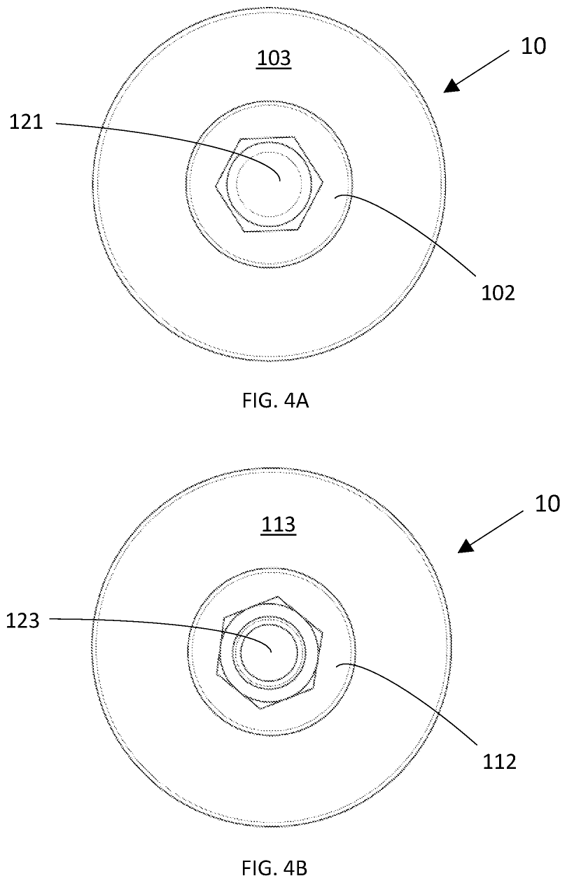

FIG. 4A illustrates a front view of the device 10 and FIG. 4B illustrates a rear view of the device 10. The head end 121 of the bolt is shown in the front view of FIG. 4A. The head 121 of the bolt in this example is hexagonal shaped although other shapes can be implemented. In FIG. 4B, the threaded end 122 is shown with a nut 123 installed. In this example, the nut 123 is hexagonal shaped and the nut 123 can be tightened using a wrench.

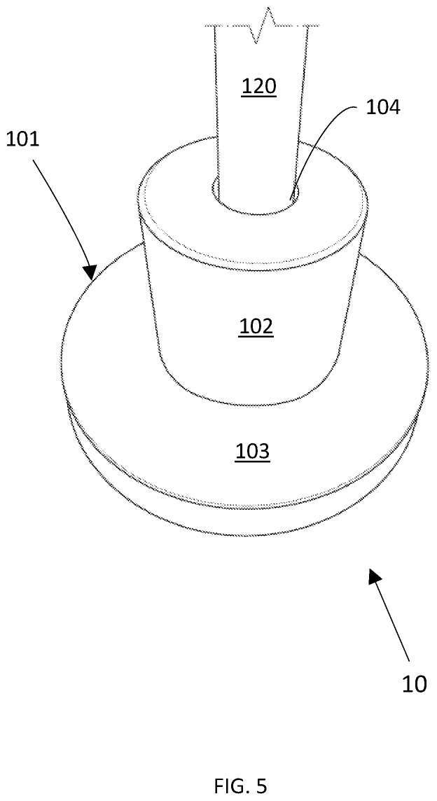

FIG. 5 illustrates a cross-sectional view of the device 10. The bolt 120 passes through a cylindrical hole 104 in the center of the first bushing 101. Similarly, the bolt 120 passes through a cylindrical hole 114 in the center of the second bushing 111 to operatively connect the bushings together.

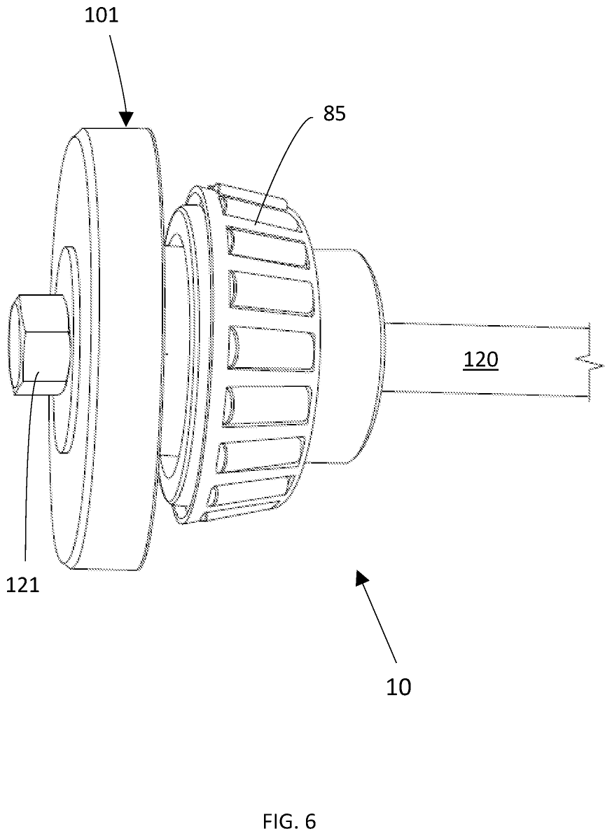

FIG. 6 illustrates a cross-sectional view of the device operatively connected to a bearing 85 of a wheel assembly. Each wheel section (wheel half) has a wheel bearing 85 located in the center of the wheel section. The bushings 101, 111 are inserted through each outer face of the wheel halves at the wheel bearings 85. The outer flanges 103 of the bushing 101 contacts the wheel bearing 85 housing while the body of the bushing supports the inner bearing race.

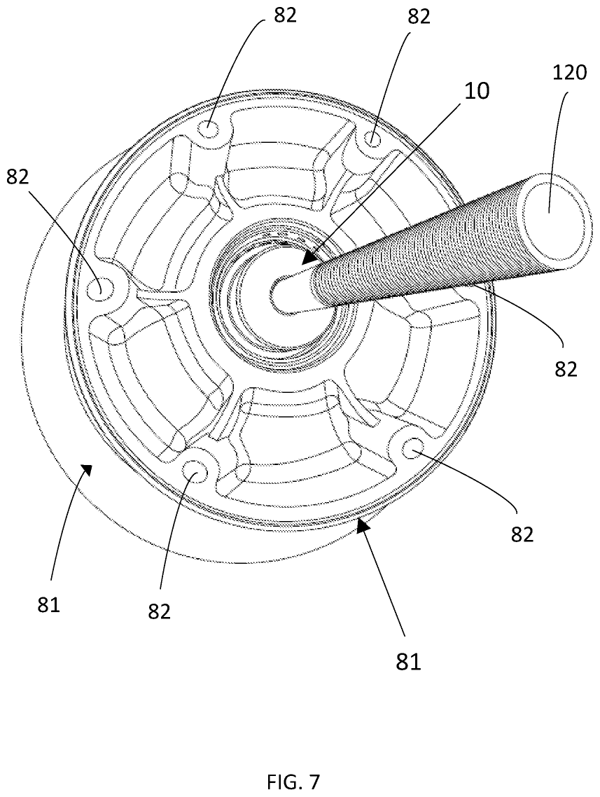

FIG. 7 illustrates a first wheel section 81 of a wheel assembly 80 operatively connected to the device 10. The first wheel section 81 includes components such as a bearing 85 and a plurality of holes 82. Those of ordinary skill in the art will understand that wheel sections can be various sizes and include many components. In this example, the first wheel section 81 includes six holes for receiving tie bolts. Similar to the first wheel section 81, a second wheel section 84 (shown in FIG. 8) includes a bearing 85 and a plurality of holes 82 for receiving tie bolts.

FIG. 8 illustrates a front perspective view of a wheel assembly 80 showing the bolt head end and the first wheel section 81. In this example, the wheel assembly 80 is a “split wheel” assembly with an inboard (first) wheel section 81 and an outboard (second) wheel section 84 operatively connected. The device 10 assists in compressing the first wheel section 81 and second wheel section 84 together. The wheel sections 81, 84 remain connected by using a plurality of tie bolts 86 and tie nuts. Only two tie bolts 86 are visible in FIG. 8 but it should be understood that additional tie bolts 86 are installed in the plurality of holes 82 to secure the wheel assembly 80. Further, a user can install a plurality of tie nuts that fit the plurality of tie bolts connecting the first wheel section 81 to the second wheel section 84. An advantage of using this device 10 is to ensure proper wheel alignment and reduce the possibility of pinched inner tubes or pinched O-rings due to wheels coming together while not properly aligned.

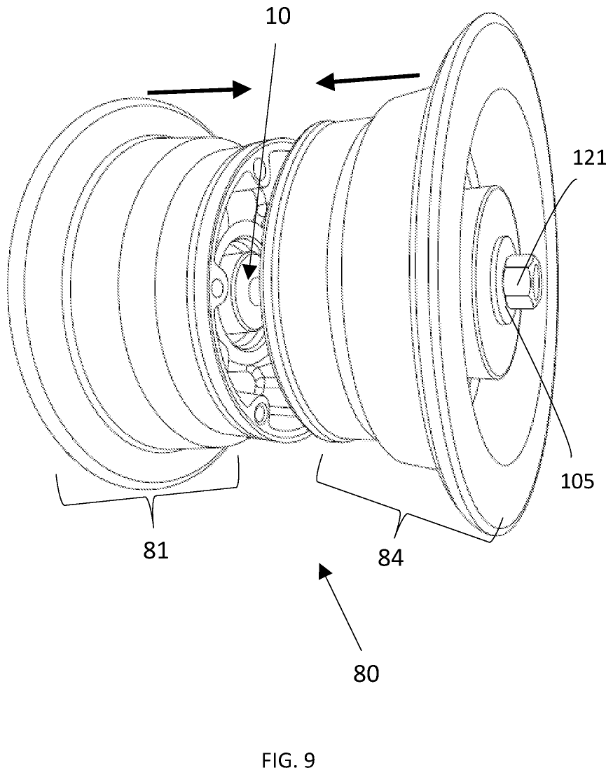

FIG. 9 illustrates a rear perspective view of a split wheel assembly 80 showing the bolt head end 121 and the second wheel section 84. As illustrated in FIG. 8 and FIG. 9, the bolt 120 can be inserted through either wheel section 81, 84 in a split wheel assembly 80. In the example split wheel assembly 80, the inboard wheel section 81 can be considered the “first wheel section” or the “second wheel section”. Likewise, the outboard wheel section 84 can be considered the “first wheel section” or the “second wheel section” in this specification and the claims.

In an example method of assembly, the first bushing 101 can be inserted through a first wheel section 81 of a wheel assembly. The second bushing 111 can be inserted through the second wheel section 84. Further, the first washer 105 can be placed on the bolt 120 and pushed toward the head end 121. Then, the bolt (with washer) can be inserted through the first bushing 101, the first wheel section 81, the second wheel section 84, and the second bushing 111. With the bolt 120 operatively connecting the bushings and wheel sections, a second washer 115 can be placed on the bolt 120 over the threaded end. A nut 123 can be placed on the bolt 120, wherein the second washer is located (disposed) between the second bushing and the nut. The nut 123 can be tightened, thereby creating a compressive force that compresses the bushings together and compresses the wheel sections together. The bolt 120 and nut 123 apply a compressive force and allow the bushings to travel in a linear motion. While the wheel sections are compressed together, a plurality of tie bolts 86 and tie nuts can be installed on the wheel sections. Adequate torque can be applied to the tie bolts to ensure the wheel sections remain attached.

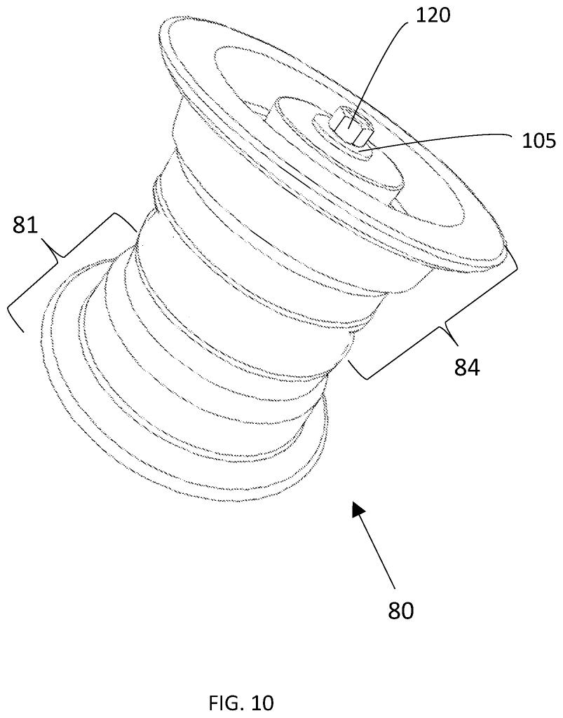

FIG. 10 illustrates a perspective view of a split wheel assembly 80 with the first wheel section 81 and second wheel section 84 fully compressed together. Within the connected wheel assembly 80, the first bushing 101 and second bushing 111 are also fully compressed together, as shown in FIG. 1. After the tie bolts and tie nuts are torqued and secured, the wheel assembly device 10 can be removed and the tire can be inflated to a proper operating pressure. The device 10 can be removed by first loosening the nut 123 and then removing the nut 123 from the bolt 120. The second washer 115 can then be removed from the bolt 120. Next, the bolt 120 can be pulled out from the operatively connected bushings and wheel sections. After removing the bolt 120, the second bushing 111 can be removed from the second wheel section. The first bushing 101 can be removed from the first wheel section 81. The components of the device 10 can be consolidated so that the device 10 can be implemented in subsequent wheel assemblies. The device 10 components can be connected together for storage and convenience, as illustrated in FIG. 1.

1. A device for assisting in a wheel assembly, the device comprising:
a. a bolt including a head end and a threaded end;
b. a nut configured to engage with the threaded end of the bolt;
c. a first washer and a second washer;
d. a first bushing including a cylindrical hole;
e. a second bushing including a cylindrical hole;
f. wherein the first bushing is configured to be inserted through a first wheel section of the wheel assembly;
g. wherein the second bushing is configured to be inserted through a second wheel section of the wheel assembly;
h. wherein the first washer is configured to be disposed between the head end and the first bushing;
i. wherein the bolt is configured to be inserted through the first washer, the first bushing, the first wheel section, the second wheel section, and the second bushing; and
j. wherein the second washer is configured to be disposed between the second bushing and a nut installed on the threaded end of the bolt.

2. The device of claim 1, wherein the first bushing and second bushing are cylindrical and T-shaped.

3. The device of claim 1, wherein the first bushing and second bushing are comprised of aluminum.

4. The device of claim 1, wherein the bolt has a coarse thread pitch.

5. A method of assembling a wheel assembly, the method comprising:
a. providing a bolt, wherein the bolt includes a head end and a threaded end;
b. providing a nut configured to engage with the threaded end of the bolt;
c. inserting a first bushing through a first wheel section of the wheel assembly;
d. inserting a second bushing through a second wheel section of the wheel assembly;
e. placing a first washer on the bolt;
f. inserting the bolt through the first bushing, the first wheel section, the second wheel section, and the second bushing;
g. placing a second washer on the bolt;
h. placing a nut on the bolt, wherein the second washer is disposed between the second bushing and the nut;
i. tightening the nut on the bolt, thereby creating a compressive force that compresses the bushings together and compresses the wheel sections together; and
j. installing a plurality of tie bolts and a plurality of tie nuts on the wheel sections.

6. The method of claim 5, further comprising:
a. loosening the nut on the bolt;
b. removing the nut from the bolt;
c. removing the second washer from the bolt;
d. removing the bolt;
e. removing the second bushing; and
f. removing the first bushing.

7. The method of claim 5, wherein the first bushing and second bushing are cylindrical and T-shaped.

8. The method of claim 5, wherein the first bushing and second bushing are comprised of aluminum.

9. The method of claim 5, wherein the bolt has a coarse thread pitch.
